(19) United States
(12) Patent Application Publication
(10) Pub. No.: US 2008/0144923 A1
(43) Pub. Date: Jun. 19, 2008

(54) TEST APPARATUS AND METHOD FOR TESTING CONTACT FINGER

(75) Inventors: CHIOU-LIN FAN, Taipei Hsien (TW); YUAN-HUNG CHIEN, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/765,450

(22) Filed: Jun. 20, 2007

(30) Foreign Application Priority Data
Dec. 15, 2006 (CN) 200610157542.5

(51) Int. Cl. G06K 9/00

(52) U.S. Cl. 382/147

(57) ABSTRACT

A contact finger test apparatus is used for testing contact fingers of a printed circuit board. The contact finger test apparatus comprises a sampler, a processor and an image-analyzer module. The sampler is for capturing an image of the contact fingers, and converting the image to the digital image. The processor is for optimizing the digital image. The image-analyzer module is for analyzing the digital image to obtain a conclusion whether there are faults in the contact fingers. A contact finger test method is also disclosed.

### BACKGROUND OF THE INVENTION

1. Field of the Invention

The present invention generally relates to a test apparatus and a test method for testing contact fingers of printed circuit boards.

2. Description of Related Art

Printed circuit boards (PCBs) are widely used in electronic devices, such as computers, mobile phones. The PCBs are electrically connected to connectors of other electronic components in the electronic devices. The PCB includes contact fingers that are rows of tabs along one or more edges of the PCB. These tabs fit into the connectors of the other electronic components. Electronic signals are transmitted between the PCBs and the other electronic components through the contact fingers. For instance, referring to FIG. 4, a memory card 10 includes a contact finger 20 including a row of tabs.

In order to be durable and resistant to tarnishing and oxidation, the contact fingers that are mainly constructed with copper tracks need to be overlaid with gold. Herein, gold is used because of its excellent conductivity and resistance to oxidation. However, there are many faults in the PCBs usually generated in manufacture or in use. Referring to FIG. 5, some kinds of faults are illustrated in the contact finger 20. These faults are an abrasion part 202, an open-circuit part 204, a spacing-lack part 206, a plating-lack part 208, a pinhole part 210, and a short-circuit part 212. Due to these faults, the electronic signals are transmitted unsteadily or even cannot be transmitted through the contact finger 20. Therefore, these faults should be picked out and repaired.

However, these faults are slight, and almost invisible to the naked eye. In practice, a manual method is used for testing the contact finger to find the faults using magnifiers. However, the test efficiency and accuracy of the manual method is low.

Therefore, a contact finger test apparatus and a contact finger test method are needed in the industry to address the aforementioned deficiencies and inadequacies.

### SUMMARY OF THE INVENTION

A contact finger test apparatus is used for testing contact fingers of a printed circuit board. The contact finger test apparatus comprises a sampler, a processor and an image-analyzer module. The sampler is for capturing an image of the contact fingers, and converting the image to the digital image. The processor is for optimizing the digital image. The image-analyzer module is for analyzing the digital image to obtain a conclusion whether there are faults in the contact fingers. A contact finger test method is also disclosed.

Other systems, methods, features, and advantages of the present contact finger test apparatus and the present contact finger test method will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present contact finger test apparatus and the present contact finger test method can be better understood with reference to following drawings. Components in the drawings are not necessarily to scale, emphasis instead being placed upon clearly illustrating the principles of the present device. Moreover, in the drawings, like reference numerals designate corresponding parts throughout the several views.

FIG. 1 is a block diagram showing a contact finger test apparatus in accordance with an exemplary embodiment.

FIG. 2 is a schematic diagram showing a concrete structure of the contact finger test apparatus of FIG. 1.

FIG. 3 is a process flow diagram illustrating a measuring method in accordance with an exemplary embodiment.

FIG. 4 is a picture illustrating a printed circuit board including contact fingers.

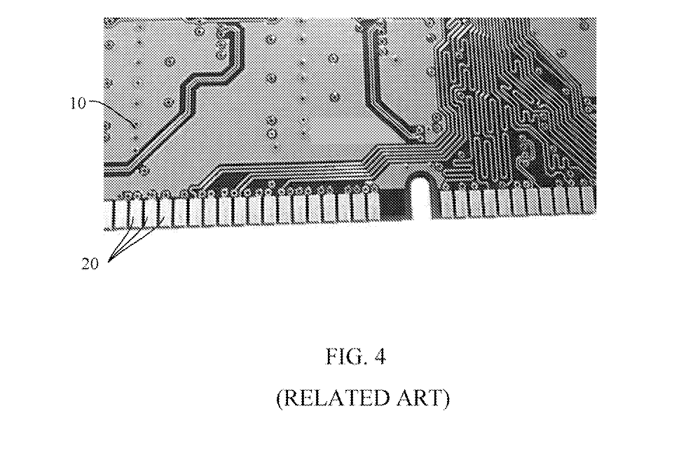

FIG. 5 is a schematic diagram showing different kinds of faults in contact fingers.

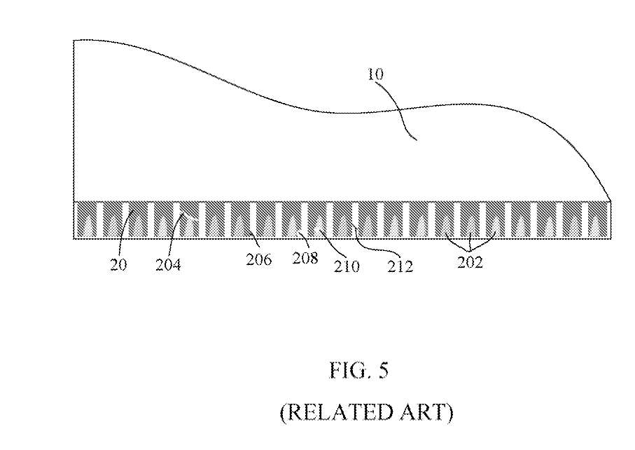

### DETAILED DESCRIPTION OF THE INVENTION

Reference will now be made to the drawings to describe preferred embodiments of the present contact finger test apparatus and the present contact finger test method.

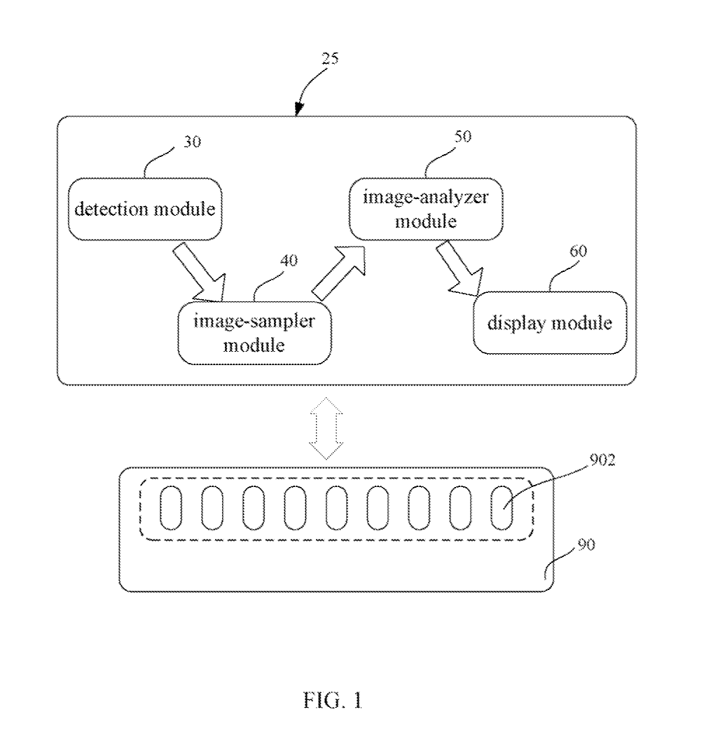

Referring to FIG. 1, a contact finger test apparatus 25 includes a detection module 30, an image-sampler module 40, an image-analyzer module 50, and a display module 60. The detection module 30 is used for detecting a printed circuit board (PCB) 90 including contact fingers 902, and signaling the image-sampler module 40 to power on when the PCB 90 is detected. The detection module 30 is also used for signaling the display module 60 to display an “error” message when the PCB 90 is not detected. The image-sampler module 40 is used for sampling an image of the contact fingers 902 and converting the image to a digital image. The image-sampler module 40 can be a charge coupled device (CCD) or a photo multiplier tube (PMT). The image-analyzer module 50 is used for analyzing the digital image to obtain analyzed data, and comparing the analyzed data with predetermined reference data that is stored in the image-analyzer module 50 to obtain a conclusion whether there are faults in the contact fingers 902. The display module 60 is used for displaying the conclusion.

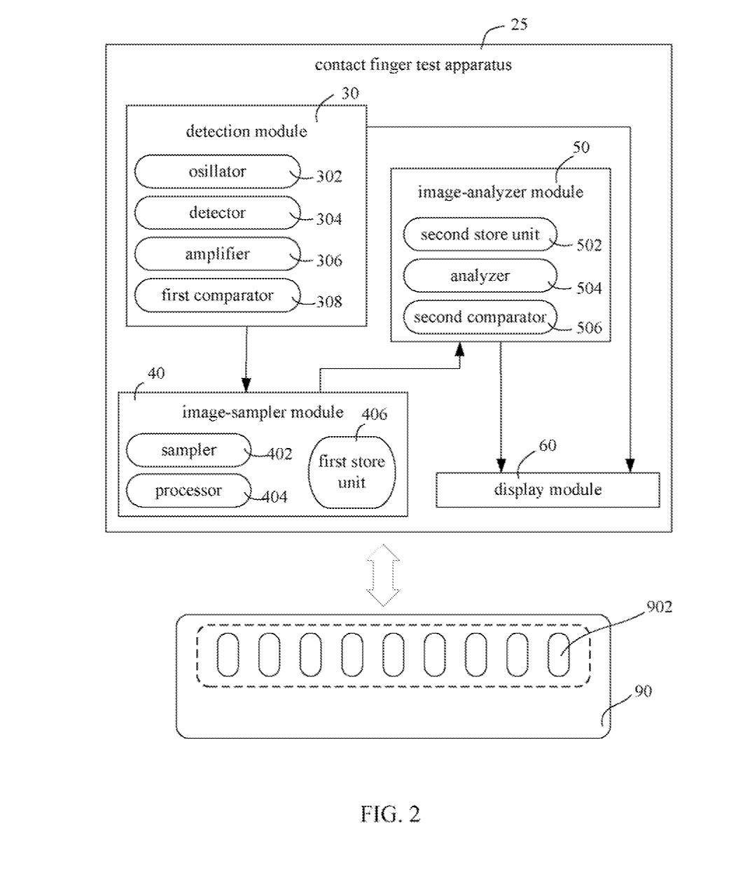

Referring to FIG. 2, a concrete structure of the contact finger test apparatus 25 is illustrated. Herein, the detection module 30 includes an osillator 302, a detector 304, an amplifier 306, and a first comparator 308. The osillator 302 is used for producing a first alternating magnetic field at a predetermined first frequency directed toward the PCB 90. When the contact fingers 902 are impacted by the first alternating magnetic field of the first frequency, a second alternating magnetic field of a second frequency is induced. The detector 304 is used for detecting the second frequency, and calculating a discrepancy between the first frequency and the second frequency, and generating a difference-frequency signal accordingly. The amplifier 306 is used for amplifying the difference-frequency signal. The discrepancy between the first frequency and the second frequency is trivial, so it is necessary to amplify the difference-frequency signal. The first comparator 308 is used for comparing a value of the difference-frequency signal after the difference-frequency signal has been amplified with a predetermined threshold value, to determine whether the contact fingers 902 of the PCB 90 are detected.

When the value of the difference-frequency signal is greater than the predetermined threshold value, the first comparator 308 signals the image-sampler module 40 to power on. In theory, the predetermined threshold value should be equal to zero, but in practice, the predetermined threshold value is set a little greater than zero because of test errors. When the value of the difference-frequency signal is less than or equal to the predetermined threshold value, the first comparator 308 signals the display module 60 to display the “error” message.

The image-sampler module 40 includes a sampler 402, a processor 404, a first store unit 406. The sampler 402 is used for capturing the image of the contact fingers 902, converting the image to the digital image. The processor 404 is used for optimizing the digital image, such as enhancing an edge of the digital image and compressing the digital image. The first store unit 406 is used for storing the digital image after the digital image has been optimized.

A processing method used by the sampler 402 to generate the digital image includes following steps: capturing an image of the contact fingers 902; converting the image to grayscale digital signals; generating a two-dimension grayscale image with a plurality of pixels; giving black color to pixels that are greater than the predetermined threshold value, and giving white color to the rest pixels.

The image-analyzer module 50 includes a second store unit 502, an analyzer 504, and a second comparator 506. The second store unit 502 is used for storing the predetermined reference data corresponding to contact fingers 902 with no faults therein. The analyzer 504 is used for analyzing the digital image to obtain analyzed data. The second comparator 506 is used for calculating difference data between the analyzed data and the reference data in the second store unit 502, and obtaining a conclusion whether there are faults in the contact fingers 902 based on the difference data.

An analyzing method based on mathematical morphology is used by the analyzer 504. Three kinds of operations of the mathematical morphology are used for analyzing the digital image. A first kind of operation is an erosion operation including the following steps: decomposing the digital image through a series of structure elements with a specific shape; setting pixel values within each structure element to a minimum value of a pixel neighborhood. A second kind of operation is a dilation operation including the following steps: decomposing the digital image through a series of structure elements with a specific shape; setting pixel values within each structure element to a maximum value of a pixel neighborhood. The third kind of operation is a morphological opening operation that is composed of a dilation operation and an erosion operation followed by the dilation operation.

The display module 60 is used for displaying information of the contact fingers 902, such as whether there are faults, then proceed to point out what they are and where they are according to the conclusion. The display module 60 is also used for displaying the “error” message indicating that the PCB 90 is not detected by the detection module 30.

As mentioned above, the image of the contact fingers 902 of the PCB 90 is captured by the contact finger test apparatus 25 using an alternating magnetic field. Furthermore, the image is processed by the contact finger test apparatus 25 automatically. Therefore, by using the contact finger test apparatus, test accuracy can be improved and test time can be shortened.

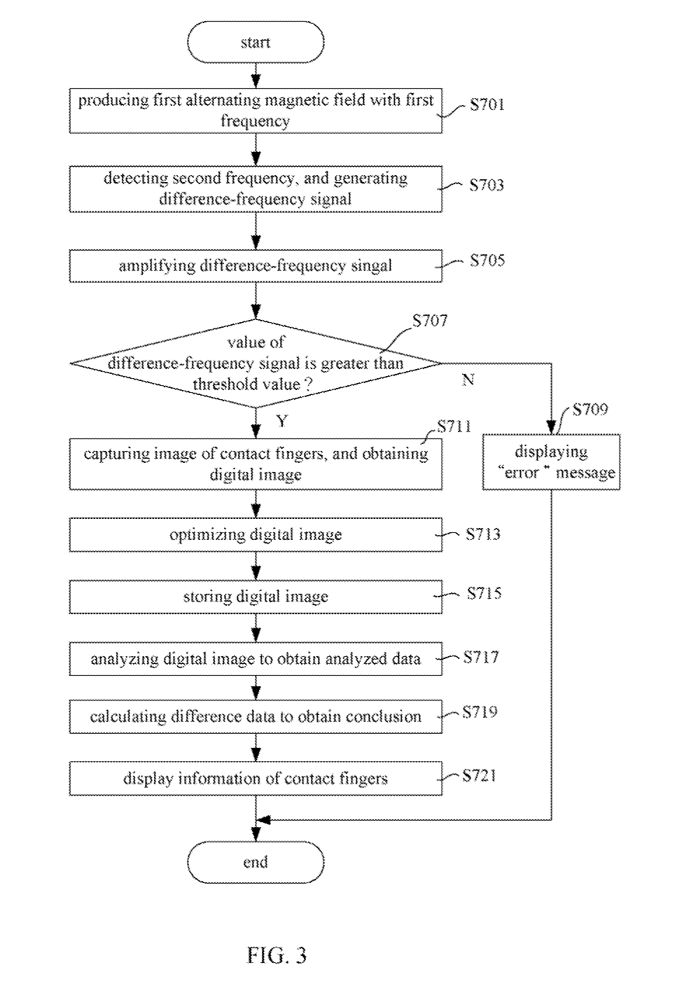

Referring to FIG. 3, a contact finger test method in accordance with an exemplary embodiment is for testing faults in the contact fingers 902 of the PCB 90. A procedure of the contact finger test method includes the following steps.

The osillator 302 produces a first alternating magnetic field at the first frequency toward the PCB 90 (step S701).

The detector 304 detects the second frequency of the second alternating magnetic field after the contact fingers 902 is impacted by the first alternating magnetic field, and calculating the discrepancy between the first frequency and the second frequency, and generates the difference-frequency signal accordingly (step S703).

The amplifier 306 amplifies the difference-frequency signal (step S705).

The first comparator 308 compares the value of the difference-frequency signal, after the difference-frequency signal has been amplified, with a predetermined threshold value that is predetermined (step S707). If the value of the difference-frequency signal is less than or equal to the predetermined threshold value, the procedure goes to step S709. If the value of the difference-frequency signal is greater than the predetermined threshold value, the procedure goes to step S711.

The first comparator 308 signals the display module 60 to display the “error” message (step S709).

The sampler 402 captures the image of the contact fingers 902, and converts the image to the digital image (step S711).

The processor 404 optimizes the digital image (step S713).

The first store unit 406 stores the digital image after the digital image has been optimized (step S715).

The analyzer 504 analyzes the digital image to obtain analyzed data (step S717).

The second comparator 506 calculates difference data between the analyzed data and the predetermined reference data stored in the second store unit 502, and obtains a conclusion whether there are faults in the contact fingers 902 based on the difference data (step S719).

The display module 60 displays information of the contact fingers 902 according to the conclusion (step S721).

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A contact finger test apparatus comprising:
a sampler for capturing an image of contact fingers of a printed circuit board, and converting the image to the digital image;
a processor for optimizing the digital image; and
an image-analyzer module for analyzing the digital image to obtain a conclusion whether there are faults in the contact fingers.

2. The contact finger test apparatus according to claim 1, wherein the image-sampler module comprises a store unit for storing the digital image after the digital image has been optimized.

3. The contact finger test apparatus according to claim 1, wherein the image-analyzer module comprises a store unit for storing predetermined reference data corresponding to contact fingers with no faults therein.

4. The contact finger test apparatus according to claim 3, wherein the image-analyzer module comprises an analyzer for analyzing the digital image to obtain analyzed data, and a comparator for calculating difference data between the analyzed data and the predetermined reference data, and obtaining the conclusion based on the difference data.

5. The contact finger test apparatus according to claim 1, further comprising a detection module for detecting a printed circuit board, and signaling the image-sampler module to power on when the printed circuit board is detected.

6. The contact finger test apparatus according to claim 5, wherein the detection module comprises an osillator for producing a first alternating magnetic field with a first frequency.

7. The contact finger test apparatus according to claim 6, wherein the detection module comprises a detector for detecting a second frequency of a second alternating magnetic field after the contact finger is impacted by the first alternating magnetic field, and calculating a discrepancy between the first frequency and the second frequency, and generating a difference-frequency signal accordingly.

8. The contact finger test apparatus according to claim 7, wherein the detection module comprises an amplifier for amplifying the difference-frequency signal.

9. The contact finger test apparatus according to claim 7, wherein the detection module comprises a comparator for comparing a value of the difference-frequency signal with a predetermined threshold value.

10. The contact finger test apparatus according to claim 9, further comprising a display module for displaying information according to the conclusion.

11. A contact finger test method comprising steps of:
capturing an image of contact fingers of a printed circuit board, and converting the image to a digital image;
optimizing the digital image;
analyzing the digital image to obtain analyzed data; and
calculating difference data between the analyzed data and predetermined reference data to obtain a conclusion whether there are faults in the contact fingers based on the difference data.

12. The contact finger test method according to claim 11, further comprising steps of:
producing a first alternating magnetic field with a first frequency toward a printed circuit board including contact fingers;
detecting a second frequency of a second alternating magnetic field after the contact fingers are impacted by the first alternating magnetic field;
calculating a discrepancy between the first frequency and the second frequency, and generating a difference-frequency signal accordingly;
amplifying the difference-frequency signal; and
comparing the value of the difference-frequency signal with a predetermined threshold value to obtain a conclusion whether there are faults in the contact fingers.

13. The contact finger test method according to claim 12, further comprising a step of:
displaying an “error” message when the value of the difference-frequency signal is less than or equal to the threshold value.

14. The contact finger test method according to claim 12, further comprising a step of:
displaying information of the contact fingers according to the conclusion.

15. The contact finger test method according to claim 11, further comprising a step of:
storing the digital image after the digital image has been optimized.
